(19) United States
(12) Patent Application Publication
(10) Pub. No.: US 2026/0058873 A1
(43) Pub. Date: Feb. 26, 2026

(54) METHOD AND APPARATUS FOR UPDATING ARTIFICIAL INTELLIGENCE SERVICE POLICY

(71) Applicant: BEIJING XIAOMI MOBILE SOFTWARE CO., LTD., Beijing (CN)

(72) Inventors: Dong CHEN, Beijing (CN); Zhibin HE, Beijing (CN)

(73) Assignee: BEIJING XIAOMI MOBILE SOFTWARE CO., LTD., Beijing (CN)

(21) Appl. No.: 19/107,104

(22) PCT Filed: Sep. 8, 2022
(86) PCT No.: PCT/CN2022/117890

§ 371 Date: Feb. 27, 2025

(51) Int. Cl. H04L 41/0894; H04L 41/16

(52) U.S. Cl. CPC H04L 41/0894; H04L 41/16

(57) ABSTRACT

A method and an apparatus for updating an artificial intelligence (AI) service policy are provided. The method is performed by an application function (AF) network element, and includes: sending an AI service policy update request to a network exposure function (NEF) network element, in which the AI service policy update request comprises an identifier of the AF network element, and updated policy information; and receiving a policy update response returned by the NEF network element.

### CROSS-REFERENCE TO RELATED APPLICATIONS

The present application is a U.S. National Stage of International Application No. PCT/CN2022/117890, filed on Sep. 8, 2022, the contents of which are incorporated herein by reference in their entireties for all purposes.

### BACKGROUND

With the continuous development of artificial intelligence (AI) technology, application of the AI technology in the field of communication is increasing.

In the related art, a network AI service may be deployed in a core network.

### SUMMARY

The present disclosure relates to the field of communication technologies, and in particular relates to a method and an apparatus for updating an artificial intelligence (AI) service policy.

According to a first aspect of embodiments of the present disclosure, there is provided a method for updating an artificial intelligence (AI) service policy. The method is performed by an application function (AF) network element, and includes: sending an AI service policy update request to a network exposure function (NEF) network element, in which the AI service policy update request includes an identifier of the AF network element, and updated policy information; and receiving a policy update response returned by the NEF network element.

According to a second aspect of embodiments of the present disclosure, there is provided a method for updating an artificial intelligence (AI) service policy. The method is performed by a network exposure function (NEF) network element, and includes: receiving an AI service policy update request sent by an application function (AF) network element, in which the AI service policy update request includes an identifier of the AF network element and updated policy information; sending the identifier of the AF network element and the updated policy information to a unified data repository (UDR); and returning a policy update response to the AF network element.

According to a third aspect of embodiments of the present disclosure, there is provided a method for updating an artificial intelligence (AI) service policy. The method is performed by a unified data repository (UDR), and includes: receiving and storing an identifier of an application function (AF) network element and updated policy information sent by a network exposure function (NEF) network element; and sending the identifier of the AF network element and the updated policy information to a policy control function (PCF) network element.

According to a fourth aspect of embodiments of the present disclosure, there is provided a method for updating an artificial intelligence (AI) service policy. The method is performed by a policy control function (PCF) network element, and includes: receiving an identifier of an application function (AF) network element and updated policy information sent by a unified data repository (UDR) network element; updating a policy control and charging (PCC) rule associated with the identifier of the AF network element according to the updated policy information; and sending the identifier of the AF network element and the PCC rule updated to a session management function (SMF) network element.

According to a fifth aspect of embodiments of the present disclosure, there is provided a method for updating an artificial intelligence (AI) service policy. The method is performed by a session management function (SMF) network element, and includes: receiving an identifier of an application function (AF) network element and a policy control and charging (PCC) rule updated sent by a policy control function (PCF) network element; and sending the identifier of the AF network element and the PCC rule updated to a user plane function (UPF) network element.

According to a sixth aspect of embodiments of the present disclosure, there is provided a method for updating an artificial intelligence (AI) service policy. The method is performed by a user plane function (UPF) network element, and includes: receiving an identifier of an application function (AF) network element and a policy control and charging (PCC) rule updated sent by a session management function (SMF) network element; and performing an AI service associated with the identifier of the AF network element according to the PCC rule updated.

According to a seventh aspect of embodiments of the present disclosure, there is provided a communication apparatus. The communication apparatus is configured in an application function (AF) network element, and includes a transceiving module configured to: send an artificial intelligence (AI) service policy update request to a network exposure function (NEF) network element, in which the AI service policy update request includes an identifier of the AF network element and updated policy information; and receive a policy update response returned by the NEF network element.

According to an eighth aspect of embodiments of the present disclosure, there is provided a communication apparatus. The communication apparatus is configured in a network exposure function (NEF) network element, and includes a transceiving module configured to: receive an artificial intelligence (AI) service policy update request sent by an application function (AF) network element, in which the AI service policy update request includes an identifier of the AF network element and updated policy information; send the identifier of the AF network element and the updated policy information to a unified data repository (UDR) network element; and return a policy update response to the AF network element.

According to a ninth aspect of embodiments of the present disclosure, there is provided a communication apparatus. The communication apparatus is configured in a unified data repository (UDR) network element, and includes a transceiving module configured to: receive and store an identifier of an application function (AF) network element and updated policy information sent by a network exposure function (NEF) network element; and send the identifier of the AF network element and the updated policy information to a policy control function (PCF) network element.

According to a tenth aspect of embodiments of the present disclosure, there is provided a communication apparatus. The communication apparatus is configured in a policy control function (PCF) network element, and includes: a transceiving module configured to receive an identifier of an application function (AF) network element and updated policy information sent by a unified data repository (UDR) network element; and a processing module configured to update a policy control and charging (PCC) rule associated with the identifier of the AF network element according to the updated policy information, in which the transceiving module is further configured to send the identifier of the AF network element and the PCC rule updated to a session management function (SMF) network element.

According to an eleventh aspect of embodiments of the present disclosure, there is provided a communication apparatus. The communication apparatus is configured in a session management function (SMF) network element, and includes a transceiving module configured to: receive an identifier of an application function (AF) network element and a policy control and charging (PCC) rule updated sent by a policy control function (PCF) network element; and send the identifier of the AF network element and the PCC rule updated to a user plane function (UPF) network element.

According to a twelfth aspect of embodiments of the present disclosure, there is provided a communication apparatus. The communication apparatus is configured in a user plane function (UPF) network element, and includes: a transceiving module configured to receive an identifier of an application function (AF) network element and a policy control and charging (PCC) rule updated sent by a session management function (SMF) network element; and a processing module configured to perform an artificial intelligence (AI) service associated with the identifier of the AF network element according to the PCC rule updated.

According to a thirteenth aspect of embodiments of the present disclosure, there is provided a communication system. The communication system includes an application function (AF) network element, a network exposure function (NEF) network element, a unified data repository (UDR) network element, a policy control function (PCF) network element, a session management function (SMF) network element and a user plane function (UPF) network element. The AF network element is configured to execute the method of the first aspect described above; the NEF network element is configured to execute the method of the second aspect described above; the UDR network element is configured to execute the method of the third aspect described above; the PCF network element is configured to execute the method of the fourth aspect described above; the SMF network element is configured to execute the method of the fifth aspect described above; and the UPF network element is configured to execute the method of the sixth aspect described above.

According to a fourteenth aspect of embodiments of the present disclosure, there is provided a communication apparatus. The communication apparatus includes a processor and a memory. The memory is configured to store a computer program, and the processor is configured to execute the computer program stored in the memory to cause the apparatus to perform the method of the first aspect described above.

According to a fifteenth aspect of embodiments of the present disclosure, there is provided a communication apparatus. The communication apparatus includes a processor and a memory. The memory is configured to store a computer program, and the processor is configured to execute the computer program stored in the memory to cause the apparatus to perform the method of the second aspect described above.

According to a sixteenth aspect of embodiments of the present disclosure, there is provided a communication apparatus. The communication apparatus includes a processor and a memory. The memory is configured to store a computer program, and the processor is configured to execute the computer program stored in the memory to cause the apparatus to perform the method of the third aspect described above.

According to a seventeenth aspect of embodiments of the present disclosure, there is provided a communication apparatus. The communication apparatus includes a processor and a memory. The memory is configured to store a computer program, and the processor is configured to execute the computer program stored in the memory to cause the apparatus to perform the method of the fourth aspect described above.

According to an eighteenth aspect of embodiments of the present disclosure, there is provided a communication apparatus. The communication apparatus includes a processor and a memory. The memory is configured to store a computer program, and the processor is configured to execute the computer program stored in the memory to cause the apparatus to perform the method of the fifth aspect described above.

According to a nineteenth aspect of embodiments of the present disclosure, there is provided a communication apparatus. The communication apparatus includes a processor and a memory. The memory is configured to store a computer program, and the processor is configured to execute the computer program stored in the memory to cause the apparatus to perform the method of the six aspect described above.

According to a twentieth aspect of embodiments of the present disclosure, there is provided a computer-readable storage medium, configured to store instructions that, when executed, cause the AF network element to execute the method of the first aspect described above, or cause the NEF network element to execute the method of the second aspect described above, or cause the UDR network element to execute the method of the third aspect described above, or cause the PCF network element to execute the method of the fourth aspect described above, or cause the SMF network element to execute the method of the fifth aspect described above, or cause the UPF network element to execute the method of the sixth aspect described above.

According to a twenty-first aspect of embodiments of the present disclosure, there is provided a computer program product including a computer program that, when run on a computer, causes the computer to perform the method of the first aspect described above, or causes the computer to perform the method of the second aspect described above, or causes the computer to perform the method of the third aspect described above, or causes the computer to perform the method of the fourth aspect described above, or causes the computer to perform the method of the fifth aspect described above, or causes the computer to perform the method of the sixth aspect described above.

According to a twenty-second aspect of embodiments of the present disclosure, there is provided a chip system. The chip system includes at least one processor and an interface, for supporting an AF network element to implement functions involved in the first aspect, or for supporting an NEF network element to implement functions involved in the second aspect, or for supporting a UDR network element to implement functions involved in the third aspect, or for supporting a PCF network element to implement functions involved in the fourth aspect, or for supporting an SMF network element to implement functions involved in the fifth aspect, or for supporting a UPF network element to implement functions involved in the sixth aspect, for example, determining or processing at least one of data and information involved in the above methods. In a possible design, the chip system further includes a memory configured to store computer programs and data necessary for a terminal. The chip system may include chips, or may include chips and other discrete devices.

According to a twenty-third aspect of embodiments of the present disclosure, there is provided a computer program that, when run on a computer, causes the computer to perform the method of the first aspect described above, or causes the computer to perform the method of the second aspect described above, or causes the computer to perform the method of the third aspect described above, or causes the computer to perform the method of the fourth aspect described above, or causes the computer to perform the method of the fifth aspect described above, or causes the computer to perform the method of the sixth aspect described above.

### BRIEF DESCRIPTION OF THE DRAWINGS

In order to more clearly illustrate embodiments of the present disclosure or the technical solutions in the related art, the following description will be given to the accompanying drawings, which are required to be used in embodiments of the present disclosure or the related art.

FIG. 1 is a schematic architecture diagram illustrating a communication system provided by an embodiment of the present disclosure.

FIG. 2 is a flow chart illustrating a method for updating an artificial intelligence (AI) service policy provided by an embodiment of the present disclosure.

FIG. 3 is a flow chart illustrating another method for updating an artificial intelligence (AI) service policy provided by an embodiment of the present disclosure.

FIG. 4 is a flow chart illustrating yet another method for updating an artificial intelligence (AI) service policy provided by an embodiment of the present disclosure.

FIG. 5 is a flow chart illustrating yet another method for updating an artificial intelligence (AI) service policy provided by an embodiment of the present disclosure.

FIG. 6 is a flow chart illustrating yet another method for updating an artificial intelligence (AI) service policy provided by an embodiment of the present disclosure.

FIG. 7 is a flow chart illustrating yet another method for updating an artificial intelligence (AI) service policy provided by an embodiment of the present disclosure.

FIG. 8 is a flow chart illustrating yet another method for updating an artificial intelligence (AI) service policy provided by an embodiment of the present disclosure.

FIG. 9 is a schematic interaction diagram illustrating a method for updating an artificial intelligence (AI) service policy provided by an embodiment of the present disclosure.

FIG. 9a is a schematic interaction diagram illustrating another method for updating an artificial intelligence (AI) service policy provided by an embodiment of the present disclosure.

FIG. 10 is a schematic diagram illustrating a communication apparatus provided by an embodiment of the present disclosure.

FIG. 11 is a schematic diagram illustrating another communication apparatus provided by an embodiment of the present disclosure.

FIG. 12 is a schematic diagram illustrating a chip provided by an embodiment of the present disclosure.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements, unless otherwise represented. The implementations set forth in the following description of illustrative embodiments do not represent all implementations consistent with the present disclosure. Instead, they are merely examples of apparatuses and methods consistent with aspects related to the present disclosure as recited in the appended claims.

To facilitate understanding, the terms involved in the present disclosure are first introduced.

### 1. Application Function (AF)

The AF is a network element used by a third-party vendor to provide an AI service, which may access other network functions via a network exposure function (NEF).

### 2. Network Exposure Function (NEF)

The NEF is a functional network element at a core network side. Network elements of 3gpp all open their capabilities to other network elements via the NEF. The NEF stores relevant information in a unified data repository (UDR), and may also obtain the relevant information from the UDR, and the NEF may only access the UDR of the same public land mobile network (PLMN) as the NEF. The NEF provides corresponding security guarantee to ensure the security of an external application to a 3gpp network, and the conversion of relevant information inside and outside the 3gpp, for example, the conversion of an AF service identifier and a data network name (DNN) and network slice selection assistance information (S-NSSAI) inside a 5G core network. Especially, network and user sensitive information must be hidden from an external network element. The NEF may obtain relevant information about other network elements by accessing the UDR, and the NEF may only access the UDR of the same PLMN as the NEF.

### 3. Policy Control Function (PCF)

The PCF is another functional network element at the core network side, which may support a unified policy framework to manage network behaviors, provide a policy rule to a network entity to implement execution, and access subscription information of a unified data repository (UDR).

### 4. Session Management Function (SMF)

The SMF is responsible for tunnel maintenance, internet protocol (IP) address allocation and management, policy enforcement and control in quality of service (QoS), charging data collection, roaming, etc.

### 5. User Plane Function (UPF)

The UPF is an important part of a system architecture of 3GPP 5G core networks, which is mainly responsible for functions related to the routing and forwarding of a user plane data packet in the 5G core network.

A network AI service may be deployed in a core network, and how to flexibly and dynamically modify an execution policy of the AI service is an urgent problem to be solved.

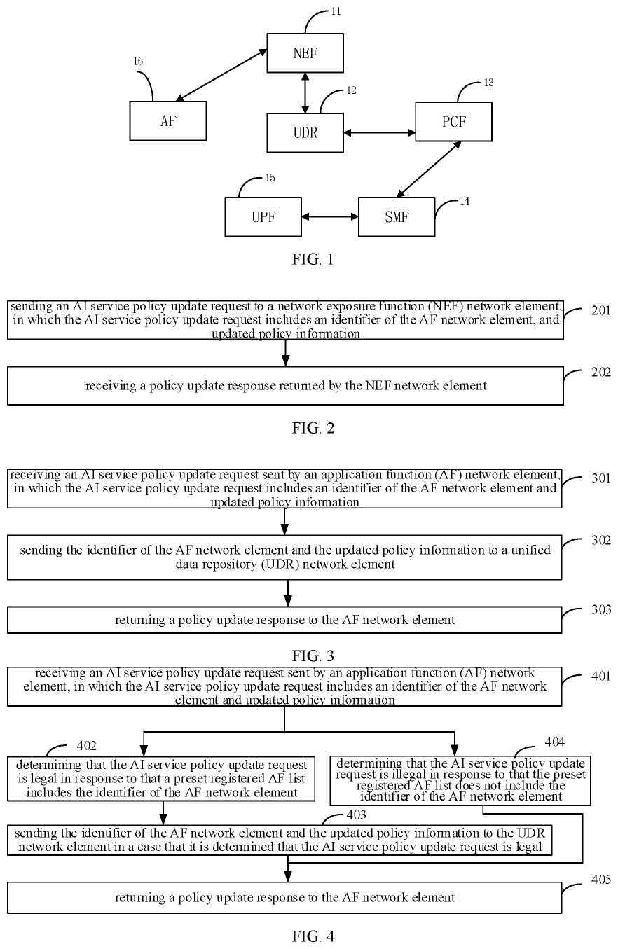

Referring to FIG. 1, which is a schematic architecture diagram illustrating a communication system provided by an embodiment of the present disclosure. The communication system may include, but is not limited to, a core network device, a terminal and an AI service device. The number and form of devices shown in FIG. 1 are merely for example and do not constitute a limitation to embodiments of the present disclosure. In practical applications, two or more core network devices, two or more terminals and two or more AI service devices may be included. The communication system shown in FIG. 1 includes five core network devices, i.e., NEF11, UDR12, PCF13, SMF14 and UPF15, and one AI service device, such as AF16.

It should be noted that the technical solutions of embodiments of the present disclosure may be applied to various communication systems, for example, a long term evolution (LTE) system, a 5th generation (5G) mobile communication system, a 5G new radio (NR) system, or other new future mobile communication systems and the like.

Each core network device in embodiments of the present disclosure may be used to provide user connection, manage a user, and complete bearing for a service, and serve as a bearer network to provide an interface to an external network. The specific form and specific technology adopted by the core network device in the communication system are not limited in embodiments of the present disclosure. For example, an access and mobility management function (AMF) device and the like may also be included in the core network device, which is not limited in the present disclosure.

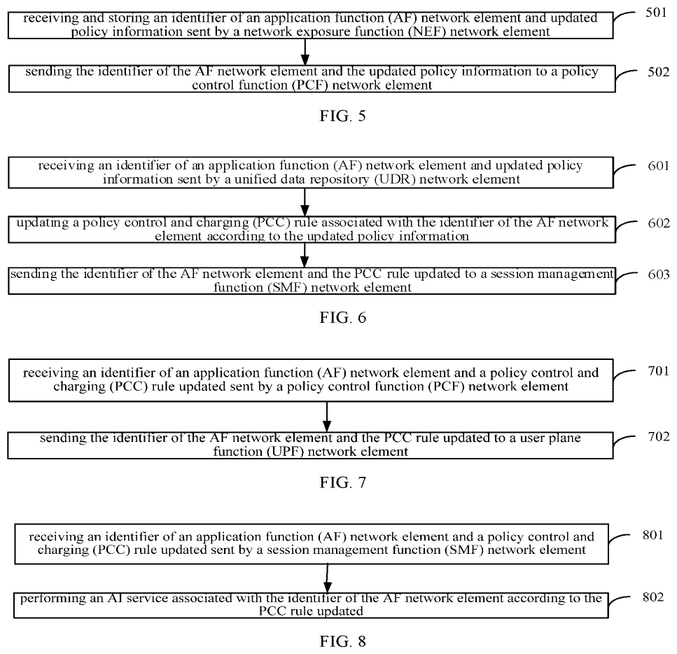

In embodiments of the present disclosure, the AF16 may perform a method for updating an AI service policy as shown in FIG. 2, the NEF11 may perform a method for updating an AI service policy as shown in FIG. 3 or FIG. 4, the UDR12 may perform a method for updating an AI service policy as shown in FIG. 5, the PCF13 may perform a method for updating an AI service policy as shown in FIG. 6, the SMF14 may perform a method for updating an AI service policy as shown in FIG. 7, and the UPF15 may perform a method as shown in FIG. 8.

The communication system provided by embodiments of the present disclosure may flexibly update the AI service policy in the core network through the interaction of various devices, i.e. not affecting the normal operation of an ongoing AI service, and may also realize the timely update of the AI service policy.

An access network device (not shown), which is an entity for transmitting or receiving signals, may also be included in the communication system in embodiments of the present disclosure. For example, the access network device may be an evolved NodeB (eNB), a transmission reception point (TRP), a next generation NodeB (gNB) in an NR system, a base station in other future mobile communication systems, or an access node in a wireless fidelity (WiFi) system and the like. The specific technology and specific device form adopted by the access network device are not limited in embodiments of the present disclosure. The access network device provided by embodiments of the present disclosure may include a central unit (CU) and a distributed unit (DU), in which the CU may also be referred to as a control unit. By using a CU-DU structure, protocol layers of the network device such as the base station may be split, the functions of some protocol layers are placed in the CU to be centrally control, and the functions of part or all of the remaining protocol layers are distributed in the DU. The DU is centrally controlled by the CU.

The communication system in embodiments of the present disclosure may also include a terminal, which is an entity on a user side for receiving or transmitting signals, such as a mobile phone. The terminal may also be referred to as a terminal device, a user equipment (UE), a mobile station (MS), a mobile terminal (MT) and the like. The terminal may be an automobile with a communication function, a smart automobile, a mobile phone, a wearable device, a Pad, a computer with a wireless transceiving function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in a smart home and the like. The specific technology and specific device form adopted by the terminal are not limited in embodiments of the present disclosure.

It may be understood that the communication system described in embodiments of the present disclosure is for a purpose of more clearly illustrating the technical solution of embodiments of the present disclosure, which does not constitute a limitation to the technical solutions provided by embodiments of the present disclosure. Moreover, it is known by those skilled in the art that the technical solutions provided by embodiments of the present disclosure are also applicable to similar technical problems with the evolution of the system architecture and the emergence of new business scenarios.

Generally, with the development of mobile communication, the functions of future communication networks, in addition to the functions of a control plane, will also include the functions of a data plane (i.e. application orientation), for example, the provision of perception capability, computing power and AI capability. These functions may be provided by a third party in large quantities. Therefore, the functions provided by the third party need to be discovered and used by the network like the functions of the control plane, and may be modified and updated flexibly and dynamically. The present disclosure is directed to implementing, at the core network, modification at the core network for the AI service provided by the third party. A method and an apparatus for updating the AI service policy provided by the present disclosure will be described in detail with reference to the accompanying drawings.

Referring to FIG. 2, FIG. 2 is a flow chart illustrating a method for updating an artificial intelligence (AI) service policy provided by an embodiment of the present disclosure. The method is performed by an application function (AF) network element. As shown in FIG. 2, the method may include, but is not limited to, the following steps.

In step 201, an AI service policy update request is sent to a network exposure function (NEF) network element, in which the AI service policy update request includes an identifier of the AF network element, and updated policy information (i.e., information of an updated AI service policy).

In the present disclosure, in a case of determining that the AI service policy provided by the AF network is updated, the AF network element may send the AI service policy update request to the NEF network element to update a policy associated with a corresponding AI service in other network elements in the core network via the NEF network element.

The identifier of the AF network element is any identifier that may uniquely determine the AI service. For example, in a case that one AF network element may provide only one AI service, the identifier of the AF network element may be an identification (ID) of the AF network element.

In an embodiment, in a case that one AF network element may provide a plurality of AI services, the AI service policy update request further includes at least one of: a public land mobile network (PLMN) identifier, or a service based interface (SBI) address. Therefore, each core network device may uniquely identify the AI service whose policy is to be updated according to the AF ID (i.e. the ID of the AF network element), the PLMN identifier, the SBI address and the like.

In an embodiment, the updated policy information may include updated complete policy information of the AI service, or may include only a part of policy information to be updated. For example, the updated policy information includes at least one of: a quality of AI service (QoAIS) parameter, or a charging policy.

In an embodiment, the updated policy information may further include an AI service-related algorithm policy, a data training selection policy and the like, which is not limited in the present disclosure.

In step 202, a policy update response returned by the NEF network element is received.

The policy update response may indicate that the AI service policy has been updated, or indicate that update of the AI service policy has failed, which is not limited in the present disclosure.

In the present disclosure, in a case that the AI service policy needs to be updated, the AF network element may send the updated policy information to the NEF network element via the AI service policy update request, to complete the update of the AI service policy in the core network via the NEF network element. Therefore, the flexible update of the AI service in the core network is realized, and the reliability and accuracy of the AI service are improved.

Referring to FIG. 3, FIG. 3 is a flow chart illustrating a method for updating an artificial intelligence (AI) service policy provided by an embodiment of the present disclosure. The method is performed by a network exposure function (NEF) network element. As shown in FIG. 3, the method may include, but is not limited to, the following steps.

In step 301, an AI service policy update request sent by an application function (AF) network element is received, in which the AI service policy update request includes an identifier of the AF network element and updated policy information.

The identifier of the AF network element is any identifier that may uniquely determine the AI service. For example, in a case that one AF network element may provide only one AI service, the identifier of the AF network element may be an identification (ID) of the AF network element.

In an embodiment, in a case that one AF network element may provide a plurality of AI services, the AI service policy update request further includes at least one of: a public land mobile network (PLMN) identifier, or a service based interface (SBI) address. Therefore, each core network device may uniquely identify the AI service whose policy is to be updated according to the AF ID, the PLMN identifier, the SBI address and the like.

In an embodiment, the updated policy information may include updated complete policy information of the AI service, or may include only a part of policy information to be updated. For example, the updated policy information includes at least one of: a quality of AI service (QoAIS) parameter, or a charging policy.

In an embodiment, the updated policy information may further include an AI service-related algorithm policy, a data training selection policy and the like, which is not limited in the present disclosure.

In step 302, the identifier of the AF network element and the updated policy information are sent to a unified data repository (UDR) network element.

In the present disclosure, after receiving the AI service policy update request sent by the AF network element, the NEF network element may send the identifier of the AF network element and the updated policy information to the UDR network element, i.e. storing the identifier of the AF network element and the updated policy information in the UDR network element, to update a policy in a policy control function (PCF) network element via the UDR network element.

In step 303, a policy update response is returned to the AF network element.

The policy update response may indicate that the AI service policy has been updated, or indicate that update of the AI service policy has failed. That is, after receiving the AI service policy update request, the NEF network element may successfully write the identifier of the AF network element and the updated policy information into the UDR network element, and may return a response, that the policy is updated successfully, to the AF network element; or, the NEF network element may return a response, that the update of the policy fails, to the AF network element due to the identifier of the AF network element being illegal, or the failure to store data in the UDR network element, etc., which is not limited in the present disclosure.

In the present disclosure, after receiving the AI service policy update request sent by the AF network element, the NEF network element may send the identifier of the AF network element and the updated policy information to the UDR network element, such that the UDR network element triggers the PCF network element to update the policy. Therefore, the flexible update of the AI service in the core network is realized, and the reliability and accuracy of the AI service are improved.

Referring to FIG. 4, FIG. 4 is a flow chart illustrating a method for updating an artificial intelligence (AI) service policy provided by an embodiment of the present disclosure. The method is performed by a network exposure function (NEF) network element. As shown in FIG. 4, the method may include, but is not limited to, the following steps.

In step 401, an AI service policy update request sent by an application function (AF) network element is received, in which the AI service policy update request includes an identifier of the AF network element and updated policy information.

The specific implementation process of step 401 may refer to the detailed description of any embodiment of the present disclosure, and will not be repeated here.

In step 402, it is determined that the AI service policy update request is legal, in response to that a preset registered AF list includes the identifier of the AF network element.

In the present disclosure, each AF network element may be registered via the NEF network element before providing an AI service, and after being registered successfully, each AF network element may provide the AI service for the communication system. Each time the NEF network element receives a registration request of the AF network element, the identifier of the AF network element may be stored in the preset registered AF list. Then, after receiving the AI service policy update request sent by the AF network element, it may be firstly traversed whether the preset registered AF list contains the identifier of the AF network element, and if so, it is indicated that the AI service policy update request is legal, otherwise, it may be determined that the AI service policy update request is illegal.

In step 403, the identifier of the AF network element and the updated policy information are sent to the UDR network element, in a case that it is determined that the AI service policy update request is legal.

That is, the NEF network element sends the identifier of the AF network element and the updated policy information to the UDR network element only in a case that it is determined that the AF network element has been registered, so as to trigger the PCF network element to update the policy.

In step 404, it is determined that the AI service policy update request is illegal, in response to that the preset registered AF list does not include the identifier of the AF network element.

In step 405, a policy update response is returned to the AF network element.

It may be understood that in a case that the AI service policy update request is legal, the policy update response may indicate that the authorization of the AI service policy update is successful; or, in a case that the AI service policy update request is illegal, the policy update response may indicate that the authorization of the AI service policy update fails.

In the present disclosure, after receiving the AI service policy update request sent by the AF network element, the NEF network element firstly performs legality check on the AF network element, and in a case that the AF network element is check to be legal, the identifier of the AF network element and the updated policy information are sent to the UDR network element, such that the UDR network element triggers the PCF network element to update the policy. Therefore, the flexible update of the AI service in the core network is realized, and the reliability and accuracy of the AI service are improved.

Referring to FIG. 5, FIG. 5 is a flow chart illustrating a method for updating an artificial intelligence (AI) service policy provided by an embodiment of the present disclosure. The method is performed by a unified data repository (UDR) network element. As shown in FIG. 5, the method may include, but is not limited to, the following steps.

In step 501, an identifier of an application function (AF) network element and updated policy information sent by a network exposure function (NEF) network element are received and stored.

The identifier of the AF network element is any identifier that may uniquely determine an AI service. For example, in a case that one AF network element may provide only one AI service, the identifier of the AF network element may be an identification (ID) of the AF network element.

In an embodiment, in a case that one AF network element may provide a plurality of AI services, the identifier of the AF network element further includes at least one of: a public land mobile network (PLMN) identifier, or a service based interface (SBI) address. Therefore, the AI service whose policy is to be updated may be uniquely identified according to the AF ID, the PLMN identifier, the SBI address and the like.

In an embodiment, the updated policy information may include updated complete policy information of the AI service, or may include only a part of policy information to be updated. For example, the updated policy information includes at least one of: a quality of AI service (QoAIS) parameter, or a charging policy.

In an embodiment, the updated policy information may further include an AI service-related algorithm policy, a data training selection policy and the like, which is not limited in the present disclosure.

In step 502, the identifier of the AF network element and the updated policy information are sent to a policy control function (PCF) network element.

In an embodiment, the UDR network element may notify the PCF network element of the identifier of the AF network element and the updated policy information via a Nudr_DM_Notify message.

In the present disclosure, after receiving the identifier of the AF network element and the updated policy information sent by the NEF network element, the UDR network element may send the identifier of the AF network element and the updated policy information to the PCF network element to notify it of updating an AI service policy. Therefore, the flexible update of the AI service in the core network is realized, and the reliability and accuracy of the AI service are improved.

Referring to FIG. 6, FIG. 6 is a flow chart illustrating a method for updating an artificial intelligence (AI) service policy provided by an embodiment of the present disclosure. The method is performed by a policy control function (PCF) network element. As shown in FIG. 6, the method may include, but is not limited to, the following steps.

In step 601, an identifier of an application function (AF) network element and updated policy information sent by a unified data repository (UDR) network element are received.

In an embodiment, the identifier of the AF network element is any identifier that may uniquely determine an AI service. For example, in a case that one AF network element may provide only one AI service, the identifier of the AF network element may be an identification (ID) of the AF network element.

In an embodiment, in a case that one AF network element may provide a plurality of AI services, the identifier of the AF network element further includes at least one of: a public land mobile network (PLMN) identifier, or a service based interface (SBI) address. Therefore, the AI service whose policy is to be updated may be uniquely identified according to the AF ID, the PLMN identifier, the SBI address and the like.

In an embodiment, the updated policy information may include updated complete policy information of the AI service, or may include only a part of policy information to be updated. For example, the updated policy information includes at least one of: a quality of AI service (QoAIS) parameter, or a charging policy.

In an embodiment, the updated policy information may further include an AI service-related algorithm policy, a data training selection policy and the like, which is not limited in the present disclosure.

In an embodiment, the PCF network element may receive the identifier of the AF network element and the updated policy information sent by the UDR network element via a Nudr_DM_Notify message.

In step 602, a policy control and charging (PCC) rule associated with the identifier of the AF network element is updated according to the updated policy information.

In general, the PCC rules of various AI services may be stored in the PCF network element. After receiving the identifier of the AF network element and the updated policy information sent by the UDR network element, an existing PCC rule associated with the identifier of the AF network element may first be obtained according to the identifier of the AF network element, and then the existing PCC rule may be updated according to the updated policy information to generate a new PCC rule.

In step 603, the identifier of the AF network element and the PCC rule updated are sent to a session management function (SMF) network element.

After determining the new PCC rule associated with the identifier of the AF network element, the PCF network element may send the rule to the SMF network element, so that the SMF network element may control a currently ongoing session according to the new PCC rule.

In an embodiment, the PCF network element, after updating the PCC rule associated with the identifier of the AF network element, may first determine whether the AI service indicated by the identifier of the AF network element is currently being invoked, i.e. whether there is a session being currently affected by the PCC rule, and if not, the PCF network element may not send the PCC rule updated to the SMF network element. Moreover, in a case that the AI service associated with the identifier of the AF network element is currently in an invoked state, i.e., there is an ongoing session being affected by the PCC rule, the PCC rule updated may be sent to the SMF network element.

In the present disclosure, after receiving the identifier of the AF network element and the updated policy information sent by the UDR network element, the PCF network element may update the PCC rule associated with the identifier of the AF network element according to the updated policy information, and synchronize the PCC rule updated to the SMF network element. Therefore, the flexible update of the AI service in the core network is realized, and the reliability and accuracy of the AI service are improved, without affecting the ongoing session.

Referring to FIG. 7, FIG. 7 is a flow chart illustrating a method for updating an artificial intelligence (AI) service policy provided by an embodiment of the present disclosure. The method is performed by a session management function (SMF) network element. As shown in FIG. 7, the method may include, but is not limited to, the following steps.

In step 701, an identifier of an application function (AF) network element and a policy control and charging (PCC) rule updated sent by a policy control function (PCF) network element are received.

In an embodiment, the identifier of the AF network element is any identifier that may uniquely determine an AI service. For example, in a case that one AF network element may provide only one AI service, the identifier of the AF network element may be an identification (ID) of the AF network element.

In an embodiment, in a case that one AF network element may provide a plurality of AI services, the AI service policy update request further includes at least one of: a public land mobile network (PLMN) identifier, or a service based interface (SBI) address. Therefore, each core network device may uniquely identify the AI service whose policy is to be updated according to the AF ID, the PLMN identifier, the SBI address and the like.

In step 702, the identifier of the AF network element and the PCC rule updated are sent to a user plane function (UPF) network element.

After receiving the identifier of the AF network element and the PCC rule updated sent by the PCF network element, the SMF network element may determine that there is an AI service associated with the identifier of the AF network element being currently executed, and thus may send the identifier of the AF network element and the PCC rule updated to the UPF network element, such that the UPF network element executes the AI service associated with the identifier of the AF network element according to a new PCC rule.

In the present disclosure, after receiving the identifier of the AF network element and the PCC rule updated sent by the PCF network element, the SMF network element may send the identifier of the AF network element and the PCC rule updated to the UPF network element, such that the UPF executes the AI service associated with the identifier of the AF network element according to the new PCC rule. Therefore, the flexible update of the AI service in the core network is realized, and the reliability and accuracy of the AI service are improved, without affecting an ongoing session.

Referring to FIG. 8, FIG. 8 is a flow chart illustrating a method for updating an artificial intelligence (AI) service policy provided by an embodiment of the present disclosure. The method is performed by a user plane function (UPF) network element. As shown in FIG. 8, the method may include, but is not limited to, the following steps.

In step 801, an identifier of an application function (AF) network element and a policy control and charging (PCC) rule updated sent by a session management function (SMF) network element are received.

The identifier of the AF network element is any identifier that may uniquely determine an AI service. For example, in a case that one AF network element may provide only one AI service, the identifier of the AF network element may be an identification (ID) of the AF network element.

In an embodiment, in a case that one AF network element may provide a plurality of AI services, the identifier of the AF network element further includes at least one of: a public land mobile network (PLMN) identifier, or a service based interface (SBI) address. Therefore, the AI service whose policy is to be updated may be uniquely identified according to the AF ID, the PLMN identifier, the SBI address and the like.

In step 802, an AI service associated with the identifier of the AF network element is performed according to the PCC rule updated.

In the present disclosure, after receiving the identifier of the AF network element and the PCC rule updated sent by the SMF network element, the UPF network element may perform the AI service associated with the identifier of the AF network element according to the PCC rule updated. Therefore, the flexible update of the AI service in the core network is realized, and the reliability and accuracy of the AI service are improved, without affecting an ongoing session.

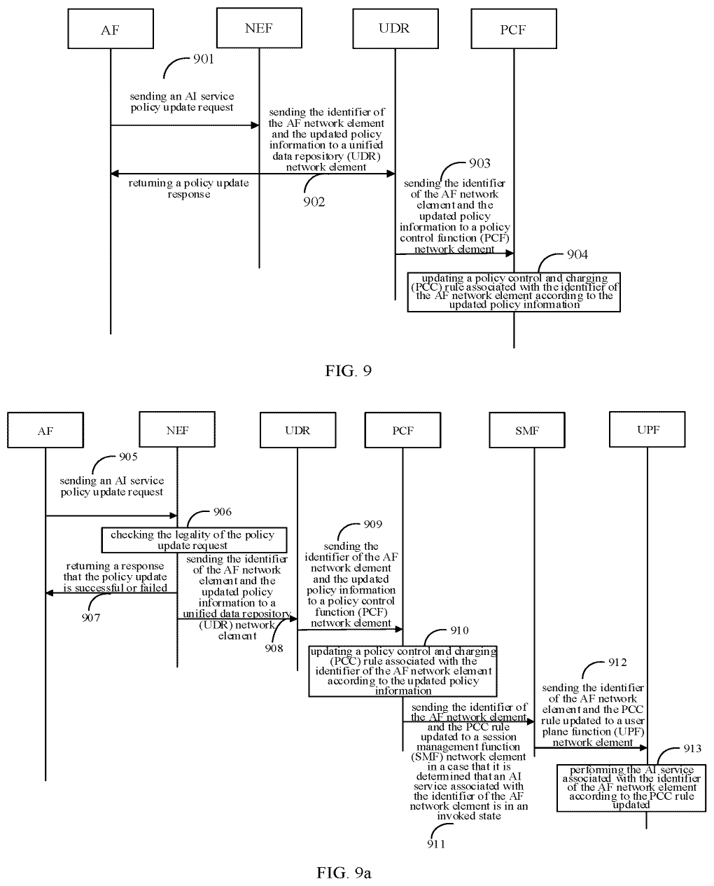

The communication system provided by the present disclosure is further described below with reference to FIG. 9. Referring to FIG. 9, FIG. 9 is a schematic interaction diagram illustrating a method for updating an artificial intelligence (AI) service policy provided by an embodiment of the present disclosure. As shown in FIG. 9, each network element in the communication system may update an AI service policy by performing a method as described below. The method may include, but is not limited to, the following steps.

In step 901, an application function (AF) network element sends an AI service policy update request to a network exposure function (NEF) network element.

The AI service policy update request includes an identifier of the AF network element, and updated policy information.

In step 902, the NEF network element sends the identifier of the AF network element and the updated policy information to a unified data repository (UDR) network element, and returns a policy update response to the AF network element.

The NEF network element returns a response that the policy update is successful or failed to the AF network element.

In step 903, the UDR network element sends the identifier of the AF network element and the updated policy information to a policy control function (PCF) network element.

In step 904, the PCF network element updates a policy control and charging (PCC) rule associated with the identifier of the AF network element according to the updated policy information.

In the present disclosure, in a case that an AI service associated with the identifier of the AF network element is not currently in an invoked state, the update of the AI service policy is completed after the PCF network element updates the PCC rule associated with the identifier of the AF network element.

In the present disclosure, for the specific implementation of steps 901-904, reference may be made to the detailed description of any embodiment of the present disclosure, which will not be repeated here.

In the present disclosure, in a case that the AF network element is to update the AI service policy, each network element of the core network may be triggered to synchronously update the AI service policy through interaction with the NEF network element. Therefore, the flexible update of the AI service in the core network is realized, and the reliability and accuracy of the AI service are improved.

The communication system provided by the present disclosure is further described below with reference to FIG. 9a. Referring to FIG. 9a, FIG. 9a is a schematic interaction diagram illustrating another method for updating an artificial intelligence (AI) service policy provided by an embodiment of the present disclosure. As shown in FIG. 9a, each network element in the communication system may update an AI service policy by performing a method as described below. The method may include, but is not limited to, the following steps.

In step 905, an application function (AF) network element sends an AI service policy update request to a network exposure function (NEF) network element.

The AI service policy update request includes an identifier of the AF network element, and updated policy information.

In step 906, the NEF network element checks the legality of the AI service policy update request.

In step 907, the NEF network element returns a response that the policy update is successful or failed to the AF network element.

In step 908, the NEF network element sends the identifier of the AF network element and the updated policy information to a unified data repository (UDR) network element.

The present disclosure does not limit the order in which step 907 and step 908 are performed. For example, step 907 and step 908 may be performed simultaneously, or step 908 may be performed first, then step 907 may be performed, etc., which is not limited in the present disclosure.

In step 909, the UDR network element sends the identifier of the AF network element and the updated policy information to a policy control function (PCF) network element.

In step 910, the PCF network element updates a policy control and charging (PCC) rule associated with the identifier of the AF network element according to the updated policy information.

In step 911, the PCF network element sends the identifier of the AF network element and the PCC rule updated to a session management function (SMF) network element, in a case that it is determined that an AI service associated with the identifier of the AF network element is in an invoked state.

In step 912, the SMF network element sends the identifier of the AF network element and the PCC rule updated to a user plane function (UPF) network element.

In step 913, the AI service associated with the identifier of the AF network element is performed according to the PCC rule updated.

In the present disclosure, for the specific implementation of steps 905-913, reference may be made to the detailed description of any embodiment of the present disclosure, which will not be repeated here.

In the present disclosure, in a case that the AF network element is to update the AI service policy, each network element of the core network may be triggered to synchronously update the AI service policy through interaction with the NEF network element. Therefore, the flexible update of the AI service in the core network is realized, and the reliability and accuracy of the AI service are improved.

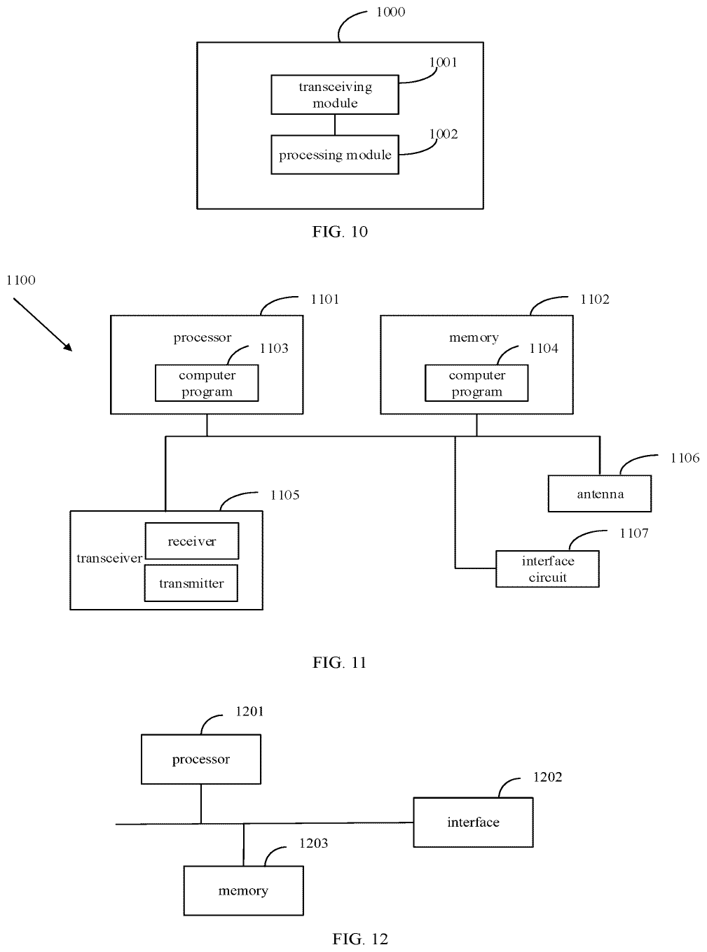

Referring to FIG. 10, FIG. 10 is a schematic diagram illustrating a communication apparatus 1000 provided by an embodiment of the present disclosure. The communication apparatus 1000 shown in FIG. 10 may include a transceiving module 1001 and a processing module 1002. The transceiving module 1001 may include a sending module and/or a receiving module. The sending module is configured to implement a sending function, and the receiving module is configured to implement a receiving function. The transceiving module 1001 may implement a sending function and/or a receiving function.

It may be understood that the communication apparatus 1000 may be a core network device, or may be an apparatus in a core network device, or may be an apparatus that may be used in conjunction with a core network device.

In a case that the communication apparatus 1000 is on an application function (AF) network element side, the transceiving module 1001 is configured to: send an artificial intelligence (AI) service policy update request to a network exposure function (NEF) network element, in which the AI service policy update request includes an identifier of the AF network element and updated policy information; and receive a policy update response returned by the NEF network element.

In an embodiment, the AI service policy update request further includes at least one of: a public land mobile network (PLMN) identifier, or a service based interface (SBI) address.

In an embodiment, the updated policy information includes at least one of: a quality of AI service parameter, or a charging policy.

It may be understood that the communication apparatus 1000 may be an NEF network element device, or may be an apparatus in an NEF network element device, or may be an apparatus that may be used in conjunction with an NEF network element device.

In a case that the communication apparatus 1000 is on an NEF network element side, the transceiving module 1001 is configured to: receive an artificial intelligence (AI) service policy update request sent by an application function (AF) network element, in which the AI service policy update request includes an identifier of the AF network element and updated policy information; send the identifier of the AF network element and the updated policy information to a unified data repository (UDR) network element; and return a policy update response to the AF network element.

In an embodiment, the transceiving module 1001 is further configured to send the identifier of the AF network element and the updated policy information to the UDR network element, in a case that it is determined that the AI service policy update request is legal.

In an embodiment, the processing module 1002 is configured to: determine that the AI service policy update request is legal, in response to that a preset registered AF list includes the identifier of the AF network element; or determine that the AI service policy update request is illegal, in response to that a preset registered AF list does not include the identifier of the AF network element.

In an embodiment, the AI service policy update request further includes at least one of: a public land mobile network (PLMN) identifier, or a service based interface (SBI) address.

In an embodiment, the updated policy information includes at least one of: a quality of AI service parameter, or a charging policy.

It may be understood that the communication apparatus 1000 may be a UDR network element device, or may be an apparatus in a UDR network element device, or may be an apparatus that may be used in conjunction with a UDR network element device.

In a case that the communication apparatus 1000 is on a UDR network element device side, the transceiving module 1001 is configured to: receive and store an identifier of an application function (AF) network element and updated policy information sent by a network exposure function (NEF) network element; and send the identifier of the AF network element and the updated policy information to a policy control function (PCF) network element.

In an embodiment, the updated policy information includes at least one of: a quality of AI service parameter, or a charging policy.

It may be understood that the communication apparatus 1000 may be a PCF network element device, or may be an apparatus in a PCF network element device, or may be an apparatus that may be used in conjunction with a PCF network element device.

In a case that the communication apparatus 1000 is on a PCF network element device side, the transceiving module 1001 is configured to receive an identifier of an application function (AF) network element and updated policy information sent by a unified data repository (UDR) network element, the processing module 1002 is configured to update a policy control and charging (PCC) rule associated with the identifier of the AF network element according to the updated policy information, and the transceiving module 1001 is further configured to send the identifier of the AF network element and the PCC rule updated to a session management function (SMF) network element.

In an embodiment, the transceiving module 1001 is further configured to send the identifier of the AF network element and the PCC rule updated to the SMF network element, in response to that an AI service associated with the identifier of the AF network element is in an invoked state.

In an embodiment, the updated policy information includes at least one of: a quality of AI service parameter, or a charging policy.

It may be understood that the communication apparatus 1000 may be an SMF network element device, or may be an apparatus in an SMF network element device, or may be an apparatus that may be used in conjunction with an SMF network element device.

In a case that the communication apparatus 1000 is on an SMF network element device side, the transceiving module 1001 is configured to: receive an identifier of an application function (AF) network element and a policy control and charging (PCC) rule updated sent by a policy control function (PCF) network element; and send the identifier of the AF network element and the PCC rule updated to a user plane function (UPF) network element.

It may be understood that the communication apparatus 1000 may be a UPF network element device, or may be an apparatus in a UPF network element device, or may be an apparatus that may be used in conjunction with a UPF network element device.

In a case that the communication apparatus 1000 is on a UPF network element device side, the transceiving module 1001 is configured to receive an identifier of an application function (AF) network element and a policy control and charging (PCC) rule updated sent by a session management function (SMF) network element, and the processing module 1002 is configured to perform an artificial intelligence (AI) service associated with the identifier of the AF network element according to the PCC rule updated.

In the present disclosure, in a case that the AF network element needs to update the AI service policy, the AF network element may initiate the AI service policy update request to the NEF network element, to request the NEF network element to trigger the update of the relevant service policy in each network element of the core network. Therefore, the flexible update of the AI service in the core network is realized, and the reliability and accuracy of the AI service are improved.

Referring to FIG. 11, FIG. 11 is a schematic diagram illustrating another communication apparatus 1100 provided by an embodiment of the present disclosure. The communication apparatus 1100 may be a network element device of a core network, or may be a chip, a chip system or a processor supporting the network element device of the core network to implement the above methods. The communication apparatus 1100 may be configured to implement the methods as described in the above method embodiments, with particular reference to the descriptions of above method embodiments.

The communication apparatus 1100 may include one or more processors 1101. The processor 1101 may be a general-purpose processor or a special-purpose processor, etc. It may be, for example, a baseband processor or a central processor. The baseband processor may be configured to process a communication protocol and communication data, and the central processor may be configured to control a communication apparatus (such as a base station, a baseband chip, a terminal, a terminal chip, a DU or a CU, etc.), execute a computer program and process data of the computer program.

In an embodiment, the communication apparatus 1100 may further include one or more memories 1102 on which a computer program 1104 may be stored, and the processor 1101 executes the computer program 1104 to cause the communication apparatus 1100 to perform the methods as described in the above method embodiments. In an embodiment, the memory 1102 may also have the data stored therein. The communication apparatus 1100 and the memory 1102 may be arranged separately or integrated together.

In an embodiment, the communication apparatus 1100 may further include a transceiver 1105 and an antenna 1106. The transceiver 1105 may be referred to as a transceiving unit, a transceiving machine, or a transceiving circuit or the like for implementing a transceiving function. The transceiver 1105 may include a receiver and a transmitter. The receiver may be referred to as a receiving machine or a receiving circuit or the like for implementing a receiving function. The transmitter may be referred to as a transmitting machine or a transmitting circuit or the like for implementing a transmitting function.

In an embodiment, the communication apparatus 1100 may further include one or more interface circuits 1107. The interface circuit 1107 is configured to receive code instructions and transmit the code instructions to the processor 1101. The processor 1101 executes the code instructions to cause the communication apparatus 1100 to perform the methods described in the above method embodiments.

In a case that the communication apparatus 1100 is an application function (AF) network element device, the transceiver 1105 is configured to execute steps 201 and 202 in FIG. 2.

In a case that the communication apparatus 1100 is a network exposure function (NEF) network element device, the transceiver 1105 is configured to execute steps 301 and 302 and the like in FIG. 3; and steps 401 and 403 and the like in FIG. 4. The processor 1101 is configured to execute step 402 and the like in FIG. 4.

In a case that the communication apparatus 1100 is a unified data repository (UDR) network element device, the transceiver 1105 is configured to execute steps 501 and 502 and the like in FIG. 5.

In a case that the communication apparatus 1100 is a policy control function (PCF) network element device, the transceiver 1105 is configured to execute steps 601 and 603 and the like in FIG. 6. The processor 1101 is configured to execute step 602 and the like in FIG. 6.

In a case that the communication apparatus 1100 is a session management function (SMF) network element device, the transceiver 1105 is configured to execute steps 701 and 702 and the like in FIG. 7.

In a case that the communication apparatus 1100 is a user plane function (UPF) network element device, the transceiver 1105 is configured to execute steps 801 and 802 and the like in FIG. 8.

In an implementation, the processor 1101 may include the transceiver for implementing receiving and transmitting functions. For example, the transceiver may be a transceiving circuit, or an interface, or an interface circuit. The transceiving circuit, interface, or interface circuit for implementing the receiving and transmitting functions may be separate or integrated. The transceiving circuit, interface or interface circuit may be configured to read and write codes/data, or the transceiving circuit, interface or interface circuit may be configured for transmission or transfer of signals.

In an implementation, the processor 1101 may store a computer program 1103 that, when run on the processor 1101, causes the communication apparatus 1100 to perform the methods described in the above method embodiments. The computer program 1103 may be embedded in the processor 1101, in which case the processor 1101 may be implemented in hardware.

In an implementation, the communication apparatus 1100 may include a circuit that may implement the functions of transmitting or receiving or communication in foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated with various IC process technologies such as a complementary metal oxide semiconductor (CMOS), a negative channel metal oxide semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus in above embodiments may be a network device or an access network device (such as a terminal in foregoing method embodiments), but the scope of the communication apparatus described in the present disclosure is not limited thereto. Moreover, the structure of the communication apparatus may not be limited by FIG. 11. The communication apparatus may be a stand-alone device or may be a part of a large device. For example, the communication apparatus may be:
(1) a stand-alone integrated circuit (IC), or a chip, or a chip system or subsystem;
(2) a set of one or more ICs, for example, the set of ICs may also include a storage component for storing the data and the computer program;
(3) an ASIC such as a modem;
(4) a module that may be embedded in other devices;
(5) a receiving machine, a terminal, an intelligent terminal, a cellular phone, a wireless device, a handset, a mobile unit, an on-vehicle device, a network device, a cloud device, an artificial intelligence device, etc. ; or
(6) others.

Regarding a case where the communication apparatus may be the chip or the chip system, reference may be made to FIG. 12, which is a schematic diagram of the chip provided by an embodiment of the present disclosure. The chip shown in FIG. 12 includes a processor 1201 and an interface 1203. One or more processors 1201 and a plurality of interfaces 1203 may be provided.

The chip may be configured to implement an application function (AF) network element, a network exposure function (NEF) network element, a unified data repository (UDR) network element, a policy control function (PCF) network element, a session management function (SMF) network element, or a user plane function (UPF) network element in embodiments of the present disclosure. In a case that the chip is configured to implement different network element devices, the interface of the chip may be configured to execute the transceiving function which may be implemented by the network element device, which will not be repeated here.

In an embodiment, the chip further includes a memory 1203 for storing necessary computer programs and data.

Those skilled in the art may further appreciate that the various illustrative logical blocks and steps described in embodiments of the present disclosure may be implemented in electronic hardware, computer software, or combinations of both. Whether such function is implemented by hardware or software depends upon particular applications and design requirements of the overall system. Those skilled in the art may implement the described function by using various methods for each particular application, but such implementation should not be considered to be beyond the scope of protection of embodiments of the present disclosure.

The present disclosure further provides a readable storage medium having instructions stored thereon that, when executed by the computer, causes the functions of any of the method embodiments described above to be implemented.

The present disclosure also provides a computer program product that, when executed by the computer, causes the functions of any of the method embodiments described above to be implemented.

In above embodiments, the present disclosure may be implemented in whole or in part by the hardware, software, firmware or their combination. When implemented in the software, the present disclosure may be implemented in whole or in part as the computer program product. The computer program product includes one or more computer programs. The computer programs, when loaded and executed on the computer, result in whole or in part in processes or functions according to embodiments of the present disclosure. The computer may be a general-purpose computer, a special-purpose computer, a computer network, or other programmable devices. The computer program may be stored in a computer-readable storage medium or transmitted from one computer-readable storage medium to another, for example, the computer program may be transmitted from one website, computer, server, or data center to another website, computer, server, or data center in a wired (e.g. a coaxial cable, fiber optic, a digital subscriber line (DSL)) or wireless (e.g. infrared, radio, microwave, etc.) manner. The computer-readable storage medium may be any available medium that may be accessed by the computer or a data storage device, such as a server, a data center, etc., that includes one or more available media. The available medium may be a magnetic medium (e.g. a floppy disk, a hard disk, a magnetic tape), an optical medium (e.g. a high-density digital video disc (DVD)), or a semiconductor medium (e.g. a solid state disk (SSD)), etc.

It is further understood that “a plurality of” in the present disclosure refers to two or more, and other quantifiers are similar thereto. “And/or”, which describes an associated relationship of associated objects, means that there may be three relationships. For example, A and/or B may mean that A exists alone, both A and B exist, and B exists alone. A character “/” generally indicates that associated objects have an “or” relationship. “A/an” and “the” in singular forms are intended to include plural forms, unless clearly indicated in the context otherwise.

It is further understood that although operations are described in a specific order in the accompanying drawings in embodiments of the present disclosure, it should not be understood that these operations are required to be performed in the specific order shown or in a serial order, or that all of the operations shown are required to be performed to obtain desired results. In certain circumstances, multitasking and parallel processing may be advantageous.

Those skilled in the art may appreciate that the first, second, and other numerical numbers involved in the present disclosure are merely for convenience of description and are not intended to limit the scope of embodiments of the present disclosure, which also do not represent a sequential order.

The term “at least one” in the present disclosure may also be described as one or more, and “a plurality of” may be two, three, four, or more, which is not limited in the present disclosure. In embodiments of the present disclosure, regarding a type of technical features, the technical features in the type of technical features are distinguished by “first”, “second”, “third”, “A”, “B”, “C” and “D”, etc., and there is no sequential order or size order between the technical features described by the “first”, “second”, “third”, “A”, “B”, “C”and “D”.

Correspondence shown in tables in the present disclosure may be configured or predefined. Values of information in each table are merely examples, and may be configured as other values, which is not limited in the present disclosure. In a case of configuring the correspondence between the information and each parameter, it is not necessarily required that all the correspondences shown in each table must be configured. For example, the correspondence shown in certain rows in the tables in the present disclosure may not be configured. As another example, appropriate transformation adjustments may be made based on the above table, such as splitting, merging, etc. Names of the parameters shown in titles of the above tables may also be other names understandable by the communication apparatus, and the values or expressions of the parameters may also be other values or expressions understandable by the communication apparatus. The above tables may also be implemented using other data structures, for example, an array, a queue, a container, a stack, a linear table, a pointer, a linked list, a tree, a graph, a struct, a class, a heap, or a hash table.

“Predefined” in the present disclosure may be understood as defined, pre-defined, stored, pre-stored, pre-negotiated, pre-configured, solidified, or pre-burned.

Those skilled in the art may appreciate that units and algorithm steps of each example described in conjunction with embodiments disclosed herein may be implemented with the electronic hardware, or the combination of the computer software and the electronic hardware. Whether such function is implemented in hardware or software depends on the specific application and design constraints of the technical solution. Those skilled in the art may implement the described function by using various methods for each particular application, but such implementation should not be considered to be beyond the scope of the present disclosure.

It will be clear to those skilled in the art that, for convenience and brevity of description, specific working procedures of the above described systems, apparatuses and units may refer to corresponding procedures in the preceding method embodiments and will not be described in detail here.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including such departures from the present disclosure as come within known or customary practice in the art. It is intended that the specification and examples be considered as illustrative only, with a true scope and spirit of the present disclosure being indicated by the following claims.

The above description is only for the specific embodiments of the present disclosure, but the scope of the present disclosure is not limited thereto. Any person skilled in the art may easily think of changes or substitutions within the technical scope of the present disclosure, which shall be covered by the protection scope of the present disclosure. Therefore, the protection scope of the present application shall be in line with the attached claims.

1. A method for updating an artificial intelligence (AI) service policy, performed by an application function (AF) network element, comprising:
sending an AI service policy update request to a network exposure function (NEF) network element, wherein the AI service policy update request comprises an identifier of the AF network element, and updated policy information; and
receiving a policy update response returned by the NEF network element.

2. The method of claim 1, wherein the AI service policy update request further comprises at least one of: a public land mobile network (PLMN) identifier, or a service based interface (SBI) address.

3. The method of claim 1, wherein the updated policy information comprises at least one of: a quality of AI service parameter, or a charging policy.

4. A method for updating an artificial intelligence (AI) service policy, performed by a network exposure function (NEF) network element, comprising:
receiving an AI service policy update request sent by an application function (AF) network element, wherein the AI service policy update request comprises an identifier of the AF network element and updated policy information;
sending the identifier of the AF network element and the updated policy information to a unified data repository (UDR) network element; and
returning a policy update response to the AF network element.

5. The method of claim 4, wherein sending the identifier of the AF network element and the updated policy information to the UDR network element comprises:
sending the identifier of the AF network element and the updated policy information to the UDR network element in a case that it is determined that the AI service policy update request is legal.

6. The method of claim 5, further comprising at least one of:
determining that the AI service policy update request is legal in response to that a preset registered AF list comprises the identifier of the AF network element; or
determining that the AI service policy update request is illegal in response to that a preset registered AF list does not comprise the identifier of the AF network element.

7. The method of claim 4, wherein the AI service policy update request further comprises at least one of: a public land mobile network (PLMN) identifier, or a service based interface (SBI) address.

8. The method of any one of claim 4, wherein the updated policy information comprises at least one of: a quality of AI service parameter, or a charging policy.

9-10. (canceled)

11. A method for updating an artificial intelligence (AI) service policy, performed by a policy control function (PCF) network element, comprising:
receiving an identifier of an application function (AF) network element and updated policy information sent by a unified data repository (UDR) network element;
updating a policy control and charging (PCC) rule associated with the identifier of the AF network element according to the updated policy information; and
sending the identifier of the AF network element and the PCC rule updated to a session management function (SMF) network element.

12. The method of claim 11, wherein sending the identifier of the AF network element and the PCC rule updated to the SMF network element comprises:
sending the identifier of the AF network element and the PCC rule updated to the SMF network element in response to that an AI service associated with the identifier of the AF network element is in an invoked state.

13. The method of claim 11, wherein the updated policy information comprises at least one of: a quality of AI service parameter, or a charging policy.

14-23. (canceled)

24. A communication apparatus, comprising a processor and a memory, wherein the memory is configured to store a computer program, and the processor is configured to execute the computer program stored in the memory to cause the apparatus to perform the method of claim 1.

25. A non-transitory computer-readable storage medium, configured to store instructions that, when executed, cause the method of claim 1 to be implemented.

26. A communication apparatus, comprising a processor and a memory, wherein the memory is configured to store a computer program, and the processor is configured to execute the computer program stored in the memory to cause the apparatus to perform the method of claim 4.

27. A communication apparatus, comprising a processor and a memory, wherein the memory is configured to store a computer program, and the processor is configured to execute the computer program stored in the memory to cause the apparatus to perform the method of claim 11.

28. A non-transitory computer-readable storage medium, configured to store instructions that, when executed, cause the method of claim 4 to be implemented.

29. A non-transitory computer-readable storage medium, configured to store instructions that, when executed, cause the method of claim 11 to be implemented.
